(19) United States
(12) Patent Application Publication
(10) Pub. No.: US 2010/0144489 A1
(43) Pub. Date: Jun. 10, 2010

(54) DEVICE AND METHOD FOR TRANSMITTING ENGINE POWER

(75) Inventor: Yoshiharu Sato, Tochigi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Komatsu, Ltd., Tokyo (JP)

(21) Appl. No.: 10/576,501

(22) PCT Filed: Oct. 15, 2004
(86) PCT No.: PCT/JP2004/015244

§ 371 Date: Apr. 20, 2006

(30) Foreign Application Priority Data
Oct. 24, 2003 (JP) 2003-363997

(51) Int. Cl. B60W 10/02; B60W 10/04

(52) U.S. Cl. 477/176

(57) ABSTRACT

An engine power transmission device for improving the acceleration performance of an engine connected to a torque converter of construction machinery in accelerating from standstill, wherein a clutch (10) capable of controlling a transmission torque and a controller (15) controlling the torque transmissibility of the clutch (10) according to the rotational speed of the engine are installed between the engine (1) and the torque converter (2). In a low speed rotation area where the engine rotational speed is, for example, 1000 rpm or below, the transmission torque is variably controlled to increase according to a rise in engine rotational speed within the range of 100% or less. In a high speed rotation area where the engine rotational speed exceeds 1000 rpm, the transmission torque is maintained at 100%.

### TECHNICAL FIELD

The present invention relates to a device and a method for transmitting the power of an engine of a construction machine or an automobile or some other working machine or the like to a torque converter, and in particular relates to a technique for enhancing the acceleration performance of the engine.

### BACKGROUND ART

In the past, in relation to the control of the slippage of a clutch of a running drive device of a vehicle, an automatic clutch slippage mode control method and device are, for example, described in Patent Reference #1.

According to this slippage mode control method and device, to a drive system of a large sized truck which comprises an engine, a clutch, a speed change mechanism, and a differential, there is provided an automatic clutch controller which generates a clutch operation signal for controlling an actuator of the clutch. According to requirements, this automatic clutch controller causes the friction clutch to slip, and engages this clutch so as to cause the input speed of the speed change mechanism to approach asymptotically to the engine speed, thus preventing the generation of torsional vibration in the drive system when engaging the clutch.

Patent Reference #1: Japanese Patent Laid-Open Publication Heisei 9-210092 (pages 5-8, FIG. 1, FIG. 5)

### DISCLOSURE OF THE INVENTION

With the above described slippage mode control method and device for an automatic clutch, the clutch is actuated according to the throttle opening amount so that, the greater is the throttle opening amount, the smaller does the slippage value for the clutch become. However, with a working machine which comprises a torque converter, such as for example a wheel loader, when the operator has stepped down upon the accelerator pedal and has tried to accelerate the engine promptly from a state of low speed rotation in order to accelerate the machine away from rest or in order to start loading work, there is a tendency for the available output torque of the engine to be insufficient with respect to the torque absorbed by the torque converter, so that it takes a certain time to accelerate the engine, and moreover it sometimes happens that a problem occurs with regard to the operator experiencing a feeling that something is wrong.

Accordingly, the object of the present invention is to improve the acceleration performance of an engine which is coupled to a torque converter.

The engine power transmission device according to the present invention comprises an engine which is controlled by a throttle; a torque converter which transmits the power of the engine to a load device; a clutch, which is provided between the engine and the torque converter, and which is capable of controlling a transmission torque transmitted thereby; a throttle actuation device which actuates the throttle; an engine rotational speed detector which detects the rotational speed of the engine; a clutch actuation device which actuates the clutch and controls the transmission torque; and a controller which, in response to the engine rotational speed detector, commands the clutch actuation device so as to control the transmission torque transmitted by the clutch according to the engine rotational speed.

In a preferred embodiment, the clutch is actuated so that the torque transmission ratio in a lower rotational speed region becomes smaller than that in a higher rotational speed region. And, in the lower rotational speed region, the clutch 10 may be actuated so that the torque transmission ratio increases along with an increase in the engine rotational speed. Furthermore, in the higher rotational speed region, the clutch may be actuated so that the torque transmission ratio becomes constant, for example 100%.

In a preferred embodiment, there is further included a throttle opening amount detector which detects the opening amount of the throttle. And the controller, in response to the engine rotational speed detector and the throttle opening amount detector, commands the clutch actuation device so as to control the transmission torque transmitted by the clutch according to the engine rotational speed and the throttle opening amount.

For example, the clutch may be actuated so that a torque transmission ratio in a lower rotational speed region becomes smaller than that in a higher rotational speed region. And the clutch may be actuated so that, in the lower rotational speed region, the torque transmission ratio increases along with an increase in the engine rotational speed and so that the torque transmission ratio decreases along with an increase in the throttle opening amount. Furthermore, the upper limit rotational speed in the lower rotational speed region may be controlled according to the throttle opening amount, so that the upper limit rotational speed in the lower rotational speed region is increased as the throttle opening amount increases.

According to another aspect of the present invention, a method for transmitting the power of an engine to a torque converter via a clutch capable of controlling torque transmission ratio comprises the steps of: controlling the engine in response to a throttle; actuating the clutch so as to control a transmission torque transmitted thereby according to the engine rotational speed.

According to the present invention, by the torque transmission ratio of the clutch which is provided between the engine and the torque converter being controlled according to the engine rotational speed, it is possible for the acceleration performance of the engine which is coupled to the torque converter to be improved. In particular, when the clutch is actuated so as to make the torque transmission ratio in the lower rotational speed region smaller than that in the higher rotational speed region, the acceleration performance of the engine in the lower rotational speed region is enhanced. Accordingly, the acceleration performance when starting the engine and moving off from rest and the like is improved.

Furthermore, if it is arranged to control the torque transmission ratio of the clutch not only according to the engine rotational speed, but also according to the throttle opening amount, then it is possible to adjust the degree of enhancement of the acceleration performance of the engine, according to the throttle actuation by the operator. In particular, if the clutch is actuated so that the torque transmission ratio decreases along with an increase in the throttle opening amount, then, the more the throttle is actuated, the more greatly enhanced is the acceleration performance of the engine.

### BRIEF DESCRIPTION OF THE DRAWINGS

FIG. 1 is a block diagram showing the structure of an engine power transmission device according to a first embodiment of the present invention;

FIG. 2 is a figure for explanation of a map or a function for specifying a torque transmission ratio set value which is stored in a storage device 22 of a controller 15, in this embodiment;

FIG. 3 is a flow chart showing the flow of processing for torque transmission ratio control performed by a calculation processing device 21 of the controller 15, in this embodiment;

FIG. 4 is a figure showing a relationship between a proportional control electrical current for a clutch actuation device 13 and the torque transmission ratio of a clutch 10 (on the vertical axis), in this embodiment;

FIG. 5 is a figure giving an output torque curve of an engine 1 and an absorbed torque curve of a torque converter 2;

FIG. 6 is a block diagram showing the structure of an engine power transmission device according to a second embodiment of the present invention;

FIG. 7 is a figure for explanation of a map or a function for specifying a torque transmission ratio set value which is stored in a storage device 22 of a controller 15, in this embodiment; and

FIG. 8 is a flow chart showing the flow of processing for torque transmission ratio control performed by a calculation processing device 21 of the controller 15, in this embodiment.

### BEST MODE FOR CARRYING OUT THE INVENTION

In the following, embodiments of the engine power transmission device according to the present invention will be explained with reference to the figures.

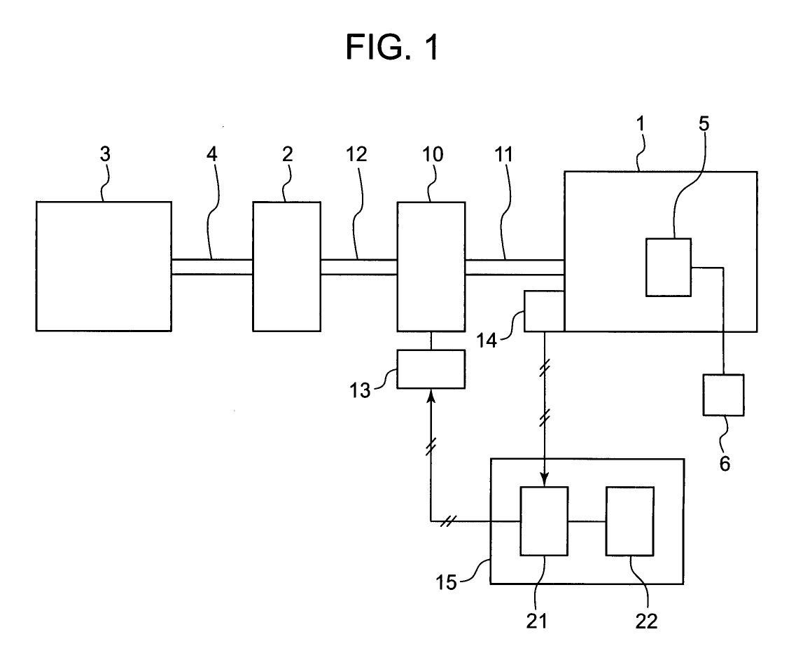

FIG. 1 is a block diagram showing the structure of an engine power transmission device according to the first embodiment of the present invention. This engine power transmission device, typically, may be applied to a construction machine such as a wheel loader, but is not only limited thereto; it may be applied to a vehicle such as a truck, or to various other types of working machine.

In FIG. 1, between an engine 1 and a torque converter 2, there is provided a clutch 10 capable of controlling the torque transmission continually or in many steps. The clutch 10 and the engine 1 are linked together by an input shaft 11, and the clutch 10 and the torque converter 2 are linked together by an output shaft 12. A speed change mechanism 3 is disposed at the output side of the torque converter 2, and the two of them are linked together by a transmission shaft 4.

A throttle 5 is provided for controlling the fuel to the engine 1, and this throttle 5 is actuated by a throttle actuation device 6, and thereby its throttle opening amount is controlled. This throttle actuation device 6 includes, for example, an accelerator pedal or an accelerator lever or the like which is actuated by the operator, and, in response to actuation of this accelerator pedal or accelerator lever or the like, it actuates the throttle 5 by a mechanical, hydraulic, vacuum, or electric actuator or the like.

The clutch 10 is actuated by a clutch actuation device 13, and thereby the torque transmitted by the clutch 10 is controlled. The clutch 10 may be, for example, a hydraulically controlled multi-plate type friction clutch. By controlling the hydraulic pressure which is supplied to the clutch 10 with a proportional valve, the clutch actuation device 13 controls the slippage amount of the friction plates of the clutch 10 from zero to its maximum, in other words controls the torque transmission ratio of the clutch 10 from 100% to 0%, continuously or in many steps. When the slippage amount is zero, in other words the torque transmission ratio is 100%, then the torque of the output shaft 12 and the torque of the input shaft 11 are equal to one another, but when the slippage amount is greater than 0, in other words the torque transmission ratio is less than 100%, then the torque of the output shaft 12 is smaller than the torque of the input shaft 11, by the amount that the torque transmission ratio is short of 100%.

An engine rotational speed detector 14 is provided to the engine 1. A controller 15 is, for example, a computer which has been programmed, and comprises a calculation processing device 21 such as a micro processor and a storage device 22 such as a RAM and a ROM. In the storage device 22, there is stored in advance a map or a function for specifying, for the calculation processing device 21, a control method for how the torque transmission ratio of the clutch 10 is to be controlled according to the engine rotational speed. In the controller 15, the calculation processing device 21 is arranged to input the detected value of the engine rotational speed from the engine rotational speed detector 14, to perform a predetermined calculation according to the map or the function which is stored in advance in the storage device 22, and to output a command signal to the clutch actuation device 13. And the clutch actuation device 13 controls the electrical current for the above described proportional valve according to this command signal from the controller 15, and thereby controls the torque transmission ratio of the clutch 10.

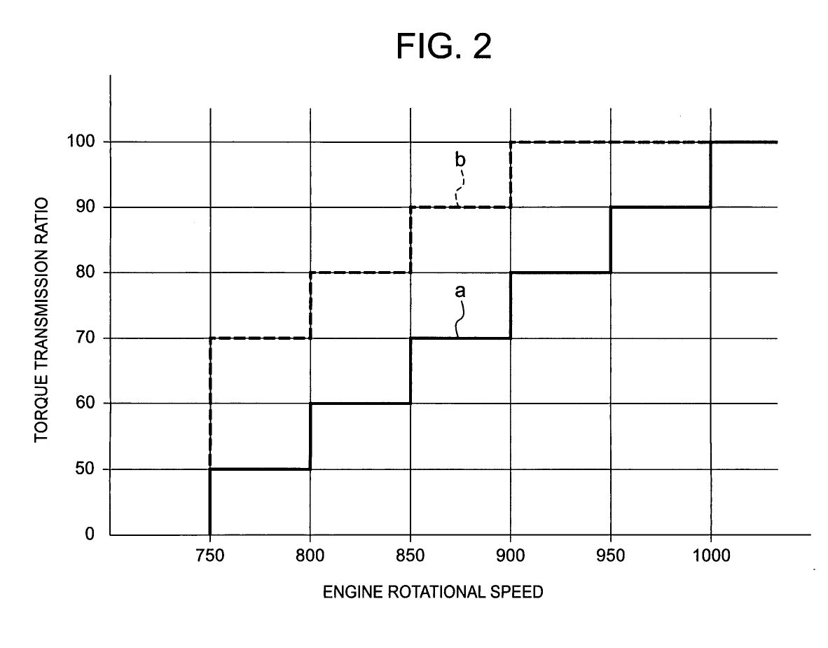

FIG. 2 is a figure for explanation of the map or the function for torque transmission ratio control which is stored in the storage device 22 of the controller 15.

In FIG. 2, the vertical axis shows the torque transmission ratio of the clutch 10 (the torque of the output shaft 12/the torque of the input shaft 11) [in %], while the horizontal axis shows the engine rotational speed [in rpm]. The solid line a in the form of steps is specified in the calculation processing device 21 by the above described map or function, and shows an example of the set values for torque transmission ratio. The calculation processing device 21 controls the torque transmission ratio of the clutch 10 according to the engine rotational speed, so that it agrees with the torque transmission ratio set value shown by the solid line a.

Thus, according to the torque transmission ratio set values shown by the solid line a, the torque transmission ratio of the clutch 10 is 50% when the engine rotational speed is 750 rpm (this is, for example, the idling rotational speed), and is 60% when the engine rotational speed is 800 rpm, while, when the engine rotational speed is 1000 rpm, it becomes 100%. And, in the range in which the engine rotational speed is greater than 1000 rpm (the maximum value may be, for example, about 3000 rpm), the torque transmission ratio is controlled to be constant at 100%, although it is not regulated by the map or function shown in FIG. 2.

In FIG. 2, the broken line b shows another example of torque transmission ratio set values. As shown by way of example by the solid lines a and b, the torque transmission ratio set value may be set as desired according to the specification or the application of the engine 1 or the torque converter 11 or of some other mechanism, or according to the situation at that time or some like condition.

In this manner, in a lower rotational speed region which includes the idling rotational speed (for example in the range 750˜1000 rpm in the case of the solid line a), control is exerted so that the torque transmission ratio increases in a range below a constant value (for example 100%) as the engine rotational speed increases. And, in a region of higher rotational speed than this lower rotational speed region (for example, in the range 1000 rpm˜the maximum rotational speed (around 3000 rpm) in the case of the solid line a), the torque transmission ratio is controlled so as to be fixed at the above described constant value (for example 100%).

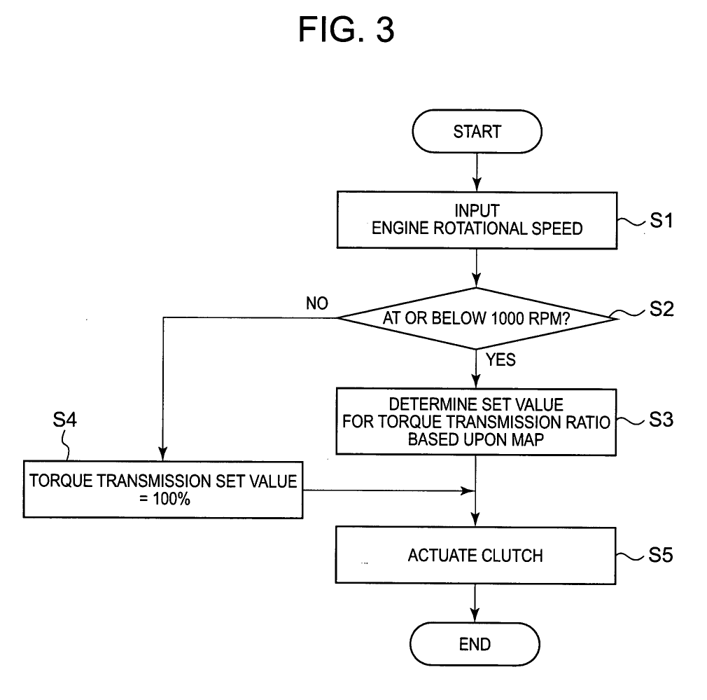

FIG. 3 shows the flow of processing for torque transmission ratio control which is performed by the calculation processing device 21 of the controller 15.

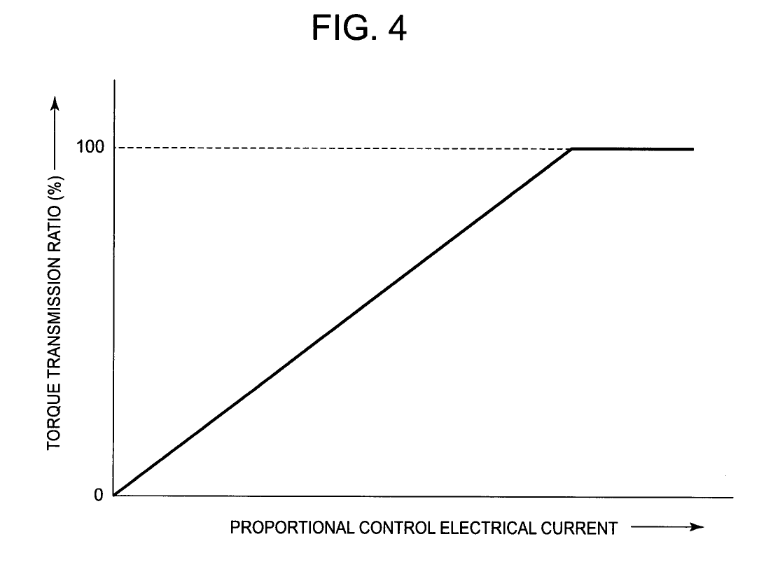

While the engine 1 is operating, the calculation processing device 21 executes the routine shown in FIG. 3 repeatedly at a short time interval of an order in which it is considered that the torque transmission ratio control is substantially always continuously performed. When the routine of FIG. 3 is started, in a step S1, the calculation processing device 21 inputs the detected value of the current engine rotational speed from the engine rotational speed detector 14, and then, in a step S2, it checks whether or not this current engine rotational speed is less than or equal to the maximum rotational speed of the above described lower rotational speed region, for example 1000 rpm (in other words, whether or not it is within the lower rotational speed region). If the result is that it is decided that the current engine rotational speed is within the lower rotational speed region, then, in a step S3, the calculation processing device 21 sets a torque transmission ratio set value which corresponds to this engine rotational speed, based upon the map or the function within the storage device 22. Furthermore if, in the step S2, it is decided that the current engine rotational speed is in a higher rotational speed region than the lower rotational speed region, then, in a step S4, the calculation processing device 21 determines the torque transmission ratio set value at 100%. Thereafter, in a step S4, the calculation processing device 21 sends a command signal to the clutch actuation device 13 to order the torque transmission ratio set value which has been determined. And, in response to this command signal, the clutch actuation device 13 controls an electrical current by proportional control, in order to operate the clutch 10 by hydraulic pressure. As shown in FIG. 4, the torque transmission ratio of the clutch 10 (on the vertical axis) is almost proportional to the above described proportional control electrical current. As a result, the torque transmission ratio of the clutch 10 is controlled so as to agree with the torque transmission ratio set value.

As has already been explained with reference to FIG. 2, by the above described torque transmission ratio control, when the engine rotational speed is in the lower rotational speed region, the torque transmission ratio of the clutch 10 is controlled to a value lower than 100%, and the torque transmission ratio is increased along with increase of the engine rotational speed; and, when the engine rotational speed exceeds the lower rotational speed region, the torque transmission ratio is kept at 100%. Accordingly, when the operator of the working machine actuates the throttle actuation device 6 and attempts to accelerate the engine 1 from a slowly rotating state (for example, the idling rotational state), as during acceleration of the working machine away from rest, while the engine rotational speed is in the lower rotational speed region (for example below 1000 rpm), the rotational speed of the output shaft 12 of the clutch 10 (in other words, the input rotational speed of the torque converter 2) is lower than the rotational speed of its input shaft 11 (in other words, than the engine rotational speed). As a result, the available torque for accelerating the engine 1 is increased, as compared with the case in which the torque transmission ratio is 100%, and accordingly the engine 1 accelerates to the desired rotational speed in a shorter time period.

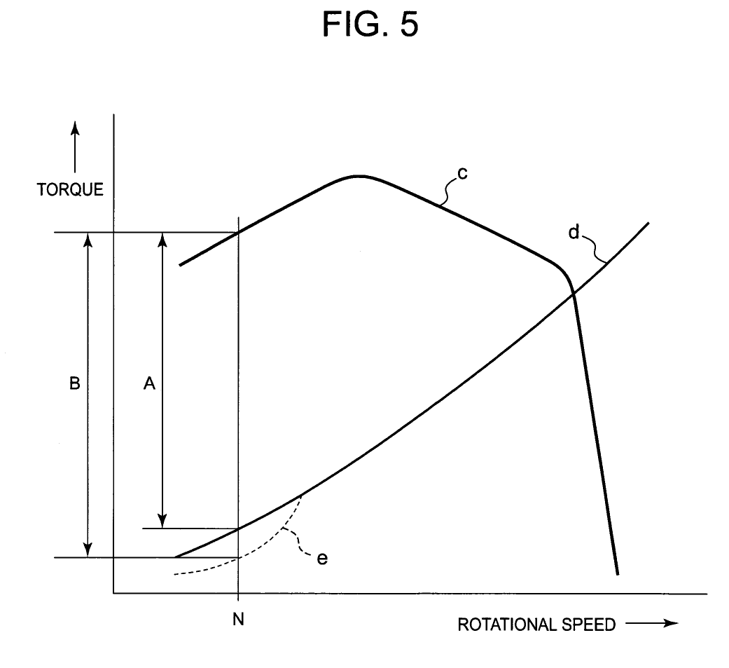

The way in which the torque available for accelerating the above described engine is increased will be understood yet more clearly by reference to the performance curve shown in FIG. 5.

In FIG. 5, the vertical axis shows the torque, and the horizontal axis shows the engine rotational speed. The curve c shows the torque curve of the engine 1, while the curve d shows the torque absorption curve of the torque converter 2. The torque absorption curve shown by the solid line d corresponds to the case when the input rotational speed of the torque converter 2 and the engine rotational speed are the same, in other words, it corresponds to the case when the torque transmission ratio of the clutch 10 is 100%.

Since the torque transmission ratio of the clutch 10 is less than 100% in the above described type of lower rotational speed region, accordingly the rotational speed of the output shaft 12 of the clutch 10, in other words the input rotational speed of the torque converter 2, is lower than the rotational speed of the input shaft 12 of the clutch 10, in other words than the engine rotational speed. Due to this, as shown by the broken line e in FIG. 5, the input torque to the torque converter 2 is smaller than the absorption torque of the engine rotational speed torque converter 2 shown by the solid line d. For example, when the engine rotational speed is N, the difference B between the output torque of the engine 1 and the input torque of the torque converter 2 is greater than the difference A between the output torque of the engine 1 and the torque absorbed by the torque converter 2 which corresponds to the engine rotational speed N. In other words, as compared to the case when the torque transmission ratio is 100%, the spare torque available for accelerating the engine is greater by the amount of the torque differential B−A. Accordingly, the acceleration performance of the engine 1 is enhanced in the lower rotational speed region of the engine, and a shortening of the acceleration time away from rest, or of the cycle time for working such as loading or the like, may be anticipated.

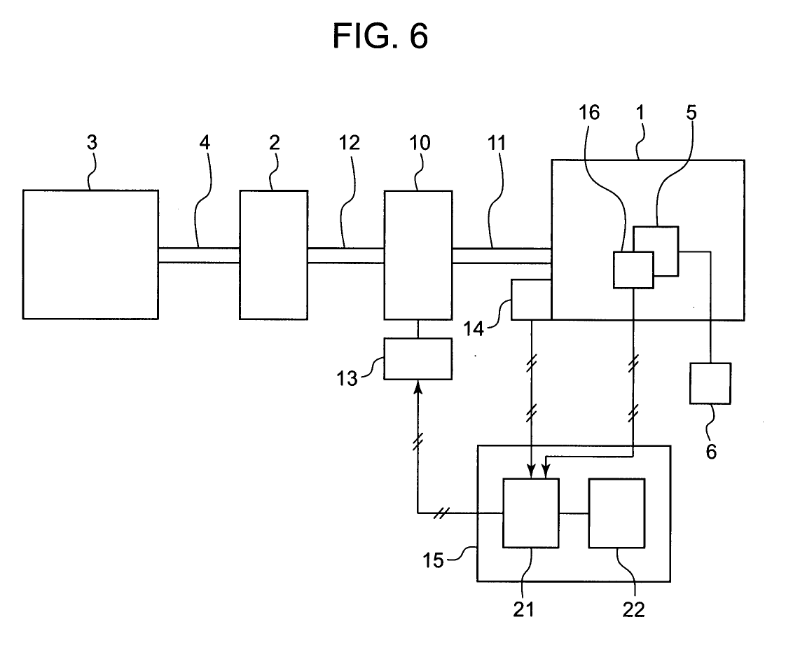

FIG. 6 is a block diagram showing the structure of an engine power transmission device according to a second embodiment of the present invention. In FIG. 6, to elements which are the same as in the first embodiment which has already been explained, the same reference symbols are affixed, and overlapped explanation of the same portions is curtailed; only the portions which are different will be explained.

As shown in FIG. 6, a throttle opening amount detector 16 is provided to the throttle 5, and its output is connected to the controller 15. The calculation control device 21 of the controller 15 inputs a throttle opening amount value detected by this throttle opening amount detector 16, as well as the value of the engine rotational speed from the engine rotational speed detector 14. And, by performing predetermined calculation processing using a map or a function which is stored in advance in a storage device 22, the calculation processing device 21 determines a torque transmission ratio set value which corresponds to the current engine rotational speed and throttle opening amount, and outputs a command signal to the clutch actuation device 13, so as to control the torque transmission ratio of the clutch 10 to the torque transmission ratio set value. In the lower rotational speed region, the torque transmission ratio of the clutch 10 is controlled to be 100% or less, so that the torque of the output shaft 12 is less than the torque of the input shaft 11. At this time the torque transmission ratio varies, not only according to the engine rotational speed, but also according to the opening amount by which the throttle is actuated by the operator.

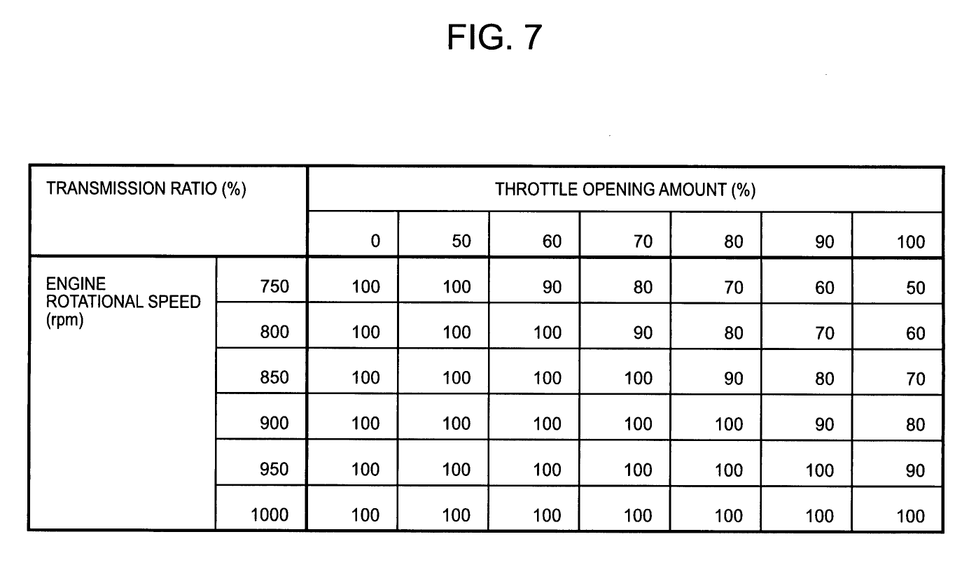

FIG. 7 is a figure for explanation of the map or the function for torque transmission ratio control, which is stored in the storage device 22 of the controller 15. FIG. 7 shows a relationship between the engine rotational speed [in rpm] and the throttle opening amount [in %] and the torque transmission ratio set value [in %].

As shown in FIG. 7, in the lower rotational speed region which includes the idling rotational speed (for example 750 rpm), the torque transmission ratio set value varies according to the engine rotational speed, while, in the rotational speed region which is higher speed than the lower rotational speed region, the torque transmission ratio set value becomes a constant value (for example 100%). And, the upper limit rotational speed is varied according to the throttle opening amount, so that, the greater is the throttle opening amount, the greater does the upper limit rotational speed of the lower rotational speed region become. For example, at throttle opening amounts of 50% or less, the upper limit rotational speed may be the idling rotational speed (and, accordingly, the torque transmission ratio set value is constant at 100% over the entire rotational speed region); while, when the throttle opening amount is 60%, the upper limit rotational speed may be 800 rpm; when the throttle opening amount is 80%, the upper limit rotational speed may be 900 rpm; and, when the throttle opening amount is 100%, the upper limit rotational speed may be 1000 rpm. And, in the lower rotational speed region, the torque transmission ratio set value increases along with increase of the engine rotational speed, and moreover the torque transmission ratio set value decreases along with increase of the throttle opening amount.

The calculation processing device 21 of the controller 15 controls the torque transmission ratio of the clutch 10 so as to make it agree with the torque transmission ratio set value which, as described above, has been determined as a function of the engine rotational speed and the throttle opening amount.

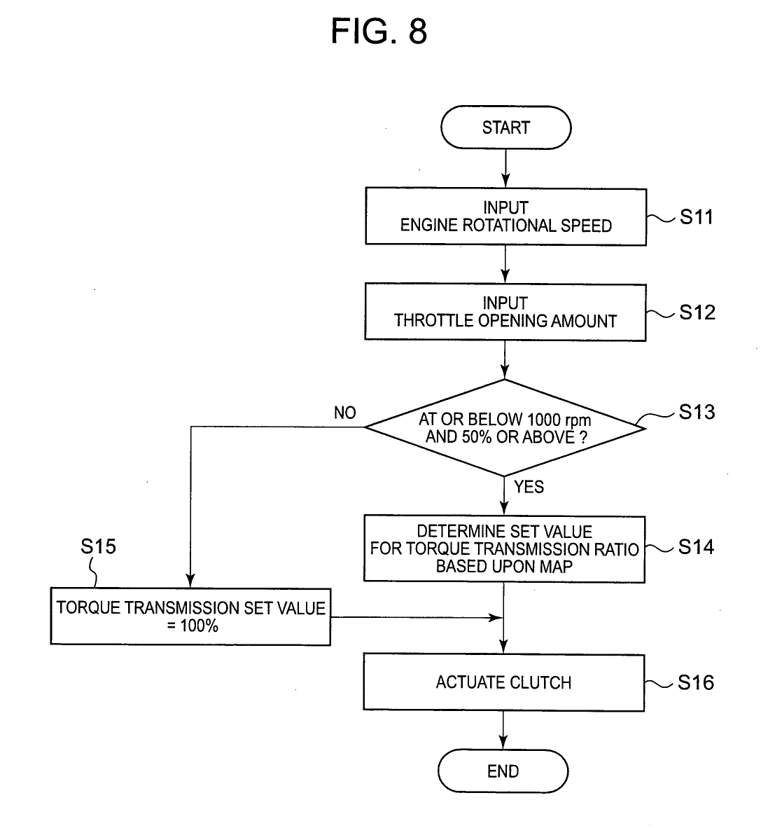

FIG. 8 shows the flow of processing for torque transmission ratio control performed by the calculation processing device 21 of the controller 15.

While the engine 1 is operating, the calculation processing device 21 executes the routine shown in FIG. 8 repeatedly at a short time interval of an order in which it is considered that the torque transmission ratio control is substantially always continuously performed. When the routine of FIG. 8 is started, in a step S11 and a step S12, the calculation processing device 21 inputs the detected values of the engine rotational speed and of the throttle opening amount, and then, in a step S13, it checks whether or not this current engine rotational speed is less than or equal to the maximum rotational speed of the lower rotational speed region (for example, in the case shown in FIG. 7, 1000 rpm), and moreover the throttle opening amount is greater than or equal to the minimum opening amount at which variable control of the torque transmission ratio is required (for example, in the case shown in FIG. 7, 50%) (in other words whether or not the operating point which is defined by the combination of the present engine rotational speed and throttle opening amount falls within the range for which variable control of the torque transmission ratio is required). If the result is that it is decided that this operating point is within the range for which such variable control is required, then, in a step S14, the calculation processing device 21 determines a torque transmission ratio set value which corresponds to the current engine rotational speed and throttle opening amount, as shown in FIG. 7, based upon the map or the function which has been stored in the storage device 22. Furthermore if, in the step S13, it is decided that the operating point is outside the range for which such variable control is required, then, in a step S15, the calculation processing device 21 determines the torque transmission ratio set value at 100%. Thereafter, in a step S16, the calculation processing device 21 commands the clutch actuation device 13 and actuates the clutch 10, thus controlling the torque transmission ratio of the clutch 10 so that it agrees with the torque transmission ratio set value which has been determined.

According to the above described control, due to the fact that the torque transmission ratio in the lower rotational speed region is less than 100%, the engine acceleration performance is enhanced. Furthermore since, even if the engine rotational speed is the same, the torque transmission ratio becomes smaller, the larger is the throttle opening amount, accordingly the enhancement of the engine acceleration performance becomes even greater. Thus, an engine acceleration performance is obtained which is matched to the amount of throttle actuation by the operator, and it is possible for the operator to perform driving operation matched to his own operating feeling.

Although embodiments of the present invention have been explained above, these embodiments are only given by way of example in order to explain the present invention, and they do not mean that the range of the present invention is only limited to these embodiments. The present invention may also be implemented by various other embodiments, provided that its gist is not departed from.

Although, in the above described embodiments, a multi-plate type friction clutch which was hydraulically controlled is used, it would also be possible to use a vacuum clutch, a magnetic clutch, a mechanical clutch, or the like. Furthermore although, in the above described embodiments, it was arranged to detect the throttle opening amount directly using a throttle opening amount detector, instead of this, it would also be acceptable to perform this detection by detecting the actuation angle, or the amount of actuation, of the accelerator pedal or throttle actuation lever.

The present invention may be applied, not only to a construction machine such as a wheel loader or a crane vehicle or the like, but also to various types of working machine which use torque converters in their power transmission systems.

1. An engine power transmission device, comprising:
an engine (1) which is controlled by a throttle (5);
a torque converter (2) which transmits a power of the engine (1) to a load device;
a clutch (10), which is provided between the engine (1) and the torque converter (2), and which is capable of controlling a transmission torque transmitted thereby;
a throttle actuation device (6) which actuates the throttle (5);
an engine rotational speed detector (14) which detects a rotational speed of the engine (1);
a clutch actuation device (13) which actuates the clutch (10) and controls the transmission torque; and
a controller (15) which, in response to the engine rotational speed detector (14), commands the clutch actuation device (13) so as to control the transmission torque transmitted by the clutch (10) according to the engine rotational speed.

2. The engine power transmission device according to claim 1, further comprising a throttle opening amount detector (16) which detects an opening amount of the throttle (5), wherein the controller, in response to the engine rotational speed detector (14) and the throttle opening amount detector (16), commands the clutch actuation device (13) so as to control the transmission torque transmitted by the clutch (10) according to the engine rotational speed and the throttle opening amount.

3. The engine power transmission device according to claim 1 or claim 2, wherein the clutch (10) is actuated so that a torque transmission ratio in a lower rotational speed region becomes smaller than that in a higher rotational speed region.

4. The engine power transmission device according to claim 3, wherein, in the lower rotational speed region, the clutch (10) is actuated so that the torque transmission ratio increases along with an increase in the engine rotational speed.

5. The engine power transmission device according to claim 4, wherein, in the higher rotational speed region, the clutch (10) is actuated so that the torque transmission ratio becomes constant.

6. The engine power transmission device according to claim 4, wherein, in the higher rotational speed region, the clutch (10) is actuated so that the torque transmission ratio becomes 100%.

7. The engine power transmission device according to claim 2, wherein the clutch (10) is actuated so that a torque transmission ratio in a lower rotational speed region becomes smaller than that in a higher rotational speed region; and
the clutch (10) is actuated so that, in the lower rotational speed region, the torque transmission ratio increases along with an increase in the engine rotational speed, and so that the torque transmission ratio decreases along with an increase in the throttle opening amount.

8. The engine power transmission device according to claim 7, wherein an upper limit rotational speed in the lower rotational speed region is controlled according to the throttle opening amount, so that the upper limit rotational speed in the lower rotational speed region is increased as the throttle opening amount increases.

9. The engine power transmission according to claim 7 or claim 8, wherein the clutch (10) is actuated so that, in the higher rotational speed region, the torque transmission ratio becomes constant.

10. An engine power transmission method for transmitting a power of an engine (1) to a torque converter (2) via a clutch (10) which is capable of controlling a torque transmission ratio, comprising the steps of:
controlling the engine (1) in response to a throttle (5); and
actuating the clutch (10) so as to control a transmission torque transmitted thereby according to an engine rotational speed.

11. The engine power transmission method according to claim 10, wherein, in the step of actuating the clutch (10), the clutch (10) is actuated so that the torque transmission ratio in a lower rotational speed region becomes smaller than that in a higher rotational speed region.

12. The engine power transmission method according to claim 11, wherein, in the lower rotational speed region, the clutch (10) is actuated so that the torque transmission ratio increases along with an increase in the engine rotational speed.
